(19) United States
(12) Patent Application Publication
(10) Pub. No.: US 2009/0193261 A1
(43) Pub. Date: Jul. 30, 2009

(54) APPARATUS AND METHOD FOR AUTHENTICATING A FLASH PROGRAM

(75) Inventors: Ching-Chao Yang, Hsinchu City (TW); Tzung-Shian Yang, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/019,825

(22) Filed: Jan. 25, 2008

(51) Int. Cl. H04L 9/00

(52) U.S. Cl. 713/181

(57) ABSTRACT

In one embodiment of the invention, an apparatus for authenticating a flash program is provided. The apparatus comprises a hardware unique key, a register storing a customer identity (ID) and a message authentication code (MAC) generation unit. The MAC generation unit acquires a root key corresponding to the hardware unique key and the customer ID, and generates a MAC for the flash program using the acquired root key, wherein the content of the register is locked to avoid modification of the stored customer ID until the next system reset.

### BACKGROUND OF THE INVENTION

1. Field of the Invention

The invention relates to flash programs, and more particularly, to an apparatus and method for authenticating a flash program.

2. Description of the Related Art

One form of security mechanism is usage of a hardware unique key (HU) key loaded into a chip. Thus, the HU key is loaded into a chip to meet cryptography requirements of confidentiality, integrity, and authenticity in various applications. As such, the HU Key is unique to each chip. Namely, if the HU key is loaded into the chip, its value can't be changed. Another advantage of using the HU key is that the key cannot be read externally. Therefore, the HU key is widely used as a security mechanism. In general, the original information transmitted into the chip may be encrypted by the HU key and the output encrypted information cannot be directly read. The HU key can be stored in any non-volatile memory.

### BRIEF SUMMARY OF THE INVENTION

In one aspect of the invention, an apparatus for authenticating a flash program is provided. The apparatus comprises a hardware unique key, a register storing a customer identity (ID) and a message authentication code (MAC) generation unit. The MAC generation unit acquires a root key corresponding to the hardware unique key and the customer ID, and generates a MAC for the flash program using the acquired root key, wherein the content of the register is locked to avoid modification of the stored customer ID until the next system reset.

In another aspect of the invention, a method for authenticating a flash program is disclosed. The method is performed by an electronic device and comprises: acquiring a hardware unique key corresponding to the electronic device; acquiring a customer identity (ID) corresponding to a customer; acquiring a root key corresponding to the hardware unique key and the customer identity; and generating a MAC for the flash program using the acquired root key.

In another aspect of the invention, a method for authenticating a flash program is disclosed. The method is performed by an electronic device and comprises: acquiring a MAC; acquiring a customer ID corresponding to a customer; determining whether the MAC corresponds to the customer ID; and booting the electronic device with the flash program when the MAC corresponds to the customer ID.

In another aspect of the invention, an apparatus for authenticating a flash program is provided. The apparatus comprises a hardware unique key, a register storing a customer identity, a key generation unit, and a lock circuit. The key generation unit generates a root key corresponding to the customer ID and the hardware unique key. The content of the register is locked by the lock circuit to avoid modification of the stored customer ID until the next system reset.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings:

FIG. 1 is a block diagram of an encrypting system.

FIG. 2 is a block diagram of the hardware architecture of an embodiment of an flash program management system according to the invention.

FIG. 3 is a block diagram of embodiment of an encrypting system according to the invention.

FIG. 4 is a schematic diagram of an embodiment of a lock circuit according to the invention.

FIG. 5 is a flowchart of an embodiment of an authentication method performed by an authentication system according to the invention.

FIG. 6 is a schematic diagram for MAC generation during flash program download.

FIG. 7 is a schematic diagram for MAC generation and validation during system booting.

FIG. 8 is a diagram of an embodiment of a MAC generation unit according to the invention.

FIG. 9 is a diagram of another embodiment of a MAC generation unit according to the invention.

FIG. 10 is a flowchart of another embodiment of an authentication method performed by an authentication system according to the invention.

FIG. 11 is a schematic diagram for MAC generation and validation during system booting.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

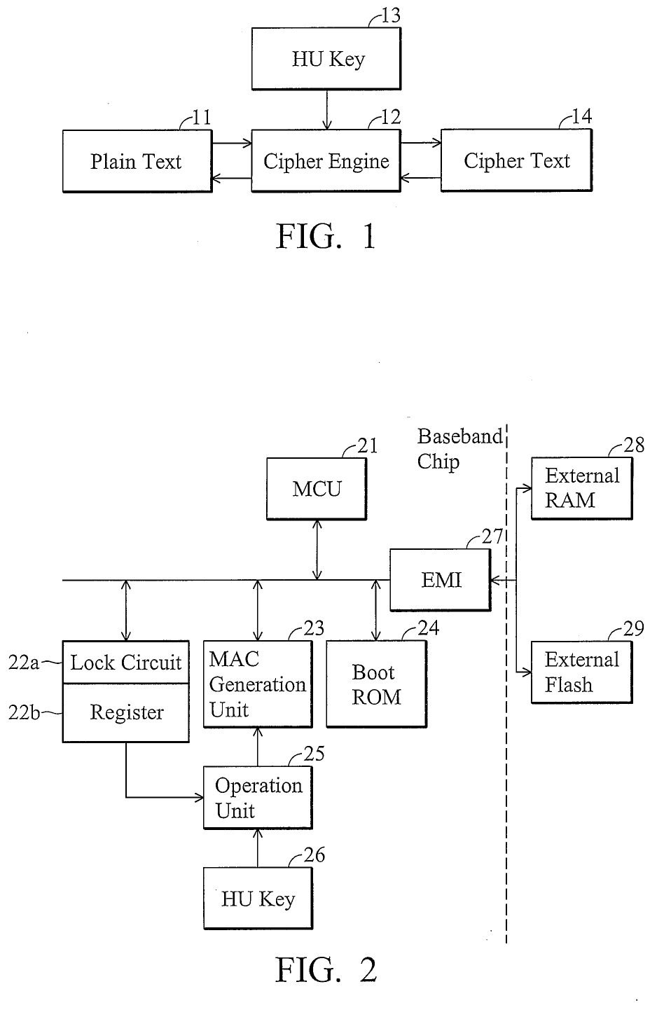

FIG. 1 is a block diagram of an encrypting system. The plain text 11 is transmitted to the cipher engine 12 for encryption. The cipher engine 12 receives the plain text 11 to generate cipher text 14, also referred to as encrypted text, based on a hardware unique (HU) key. This is not prior art for purposes of determining the patentability of the invention and merely shows a problem found by the inventors. In this system, the HU key 13 is only accessible by the cipher engine 12 and the cipher engine 12 can be manipulated by software control. Thus, the system has some security loopholes. Namely, the HU key 13 and cipher engine 12 are usually embedded in a chip before shipping and the HU key 13 cannot be modified by any means. However, a hacker may simply discover the original plain text 11 by writing software to manipulate the cipher engine 12 to decrypt the cipher text 14, without breaking the HU key 13.

FIG. 2 is a block diagram of the hardware architecture of an embodiment of a flash program management system according to the invention. The flash program management system is embedded in a chip or an electronic device. When the whole system is reset, the microcontroller (MCU) 21 initially executes the boot program stored in the boot ROM 24. The executed boot program detects whether a flash program is to be downloaded. When a flash program is to be downloaded, customer information corresponding to the flash program is provided, wherein the customer information comprises a customer ID. The customer ID of the provided customer information is subsequently written in the register 22b. When the customer information is stored in the register 22b, the lock circuit 22a locks the content of the register 22b to avoid modification of the stored customer ID until the next system reset. The operation unit 25 receives the customer ID from the register 22b and the HU key 26 to generate a root key. In another embodiment, the operation unit 25 generates the root key based on the customer information and the HU key 26. The message authentication code (MAC) generation unit 23 generates a MAC according to the customer information and the root key. The MAC and the customer information are stored in the external flash 29 via the external memory interface (EMI) 27.

When a flash program is not to be downloaded, customer information corresponding to a flash program is acquired from the external flash 29 via the EMI 27, wherein the customer information comprises a customer ID and the flash program is stored in the external flash 29. A MAC is acquired from the external flash 29 via the EMI 27. It is determined whether the acquired MAC conforms to the acquired customer information. System booting is performed with the flash program after determining the MAC conforms to the customer information.

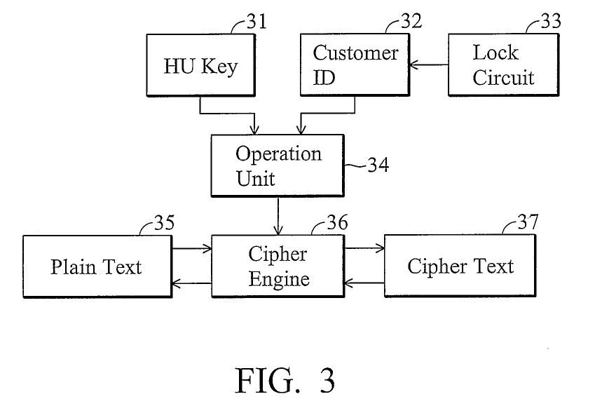

FIG. 3 is a block diagram of an embodiment of an encrypting system according to the invention. The operation unit receives the HU key 31 and the customer ID 32 to generate a root key or a MAC. A software controllable registers (software UID) is used to save the customer's information, such as the customer ID 32. The lock circuit 33 locks the register storing the customer ID to avoid modification of the stored customer ID until the next system reset. The cipher engine 36 receives the plain text 35 to generate cipher text 37, also referred to as encrypted text, based on output from the operation unit 34. In this system, the HU key is provided during the manufacturing of the chip and the customer ID is given by the customer. In this system, the customer unique ID accompanying with the HU key will be used to perform encryption and decryption. This will make the cipher text unique to each customer (i.e. customer unique ID) even if the HU key is the same. The content of the register is written and locked by a boot ROM program, such as that stored in the boot ROM 24 of FIG. 2, after certification.

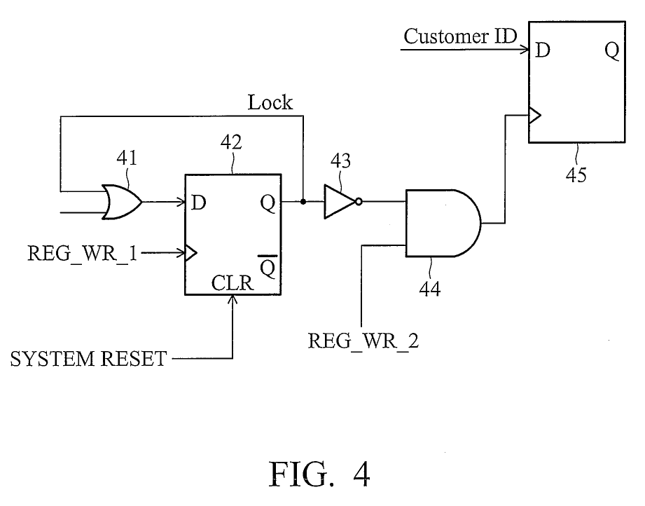

FIG. 4 is a schematic diagram of an embodiment of a lock circuit according to the invention. During system reset, a signal SYSTEM RESET is input to the D flip-flop 42 to clear the data latched therein. The D flip-flop 42 has a clock input terminal receiving a signal REG_WR_1, and a data input terminal receiving the output of an OR gate 41. The OR gate has a first input terminal receiving a control signal, and a second input terminal coupled to the output terminal Q of the D flip-flop 42. An inverter 43 receives and inverts the output signal from the D flip-flop 42, and the inverted signal is then transmitted to an AND gate 44. The AND gate 44 further receives a signal REG_WR_2. The signal REG_WR_2 may be constantly set to one. The D flip-flop 45 has a clock input terminal receiving the output signal of the AND gate 44, and a data input terminal receives the customer ID. Since one D flip-flop unit latches only one bit, the number of the D flip-flop 45 depends on the number of the bits of the customer ID. The control signal is set to 0 when the customer ID is writing to the D flip-flop 45, and the control signal is set to 1 after completing writing of customer ID. When the customer ID is writing to the D flip-flop 45, the signal REG_WR_1 and the signal REG_WR_2 are asserted. In this embodiment, the signal REG_WR_1 and the signal REG_WR_2 are controlled by the boot ROM program. It is to be understood that the OR gate 41, D flip-flop 42 inverter 43 and AND gate 44 may be considered as a lock circuit. Once a signal SYSTEM RESET is input to the D flip-flop 42, the output of the D flip-flop 42 is zero, enabling the AND gate 44 to receive the inverted signal of one, and then, the clock input of D flip-flop 45 goes high to allow that the customer ID is written in the D flip-flop 45. After that, the output of D flip-flop 42 maintains one until another signal SYSTEM RESET is input to the D flip-flop 42, enabling the customer ID latched by the D flip-flop 45 constant.

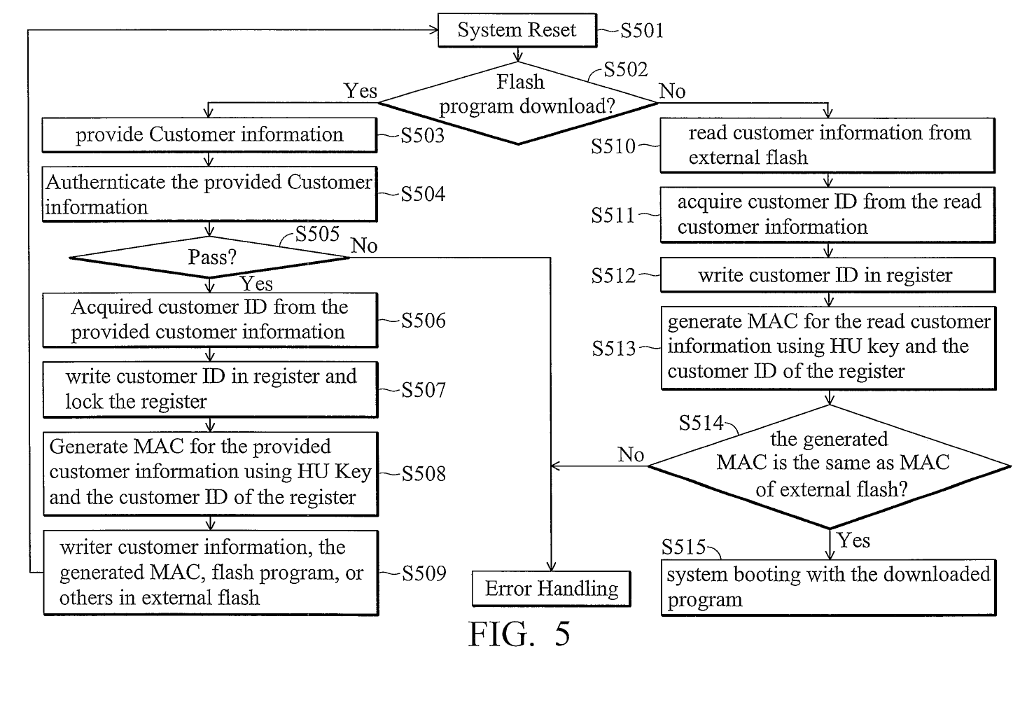

FIG. 5 is a flowchart of an embodiment of an authentication method performed by an authentication system according to the invention. In the step S501, the whole system is reset. In step S502, the authentication system detects whether a flash program is to be downloaded according to an external control signal. Note that the flash program may be downloaded from an external electronic apparatus such as a personal computer, a notebook, a personal digital assist, a mobile phone, a smart phone and the like. If a flash program is waiting to be downloaded, the method processes steps S503 to S509. If there is no flash program to be downloaded, the method processes steps S510 to S515. In step S503, customer information corresponding to the flash program is provided for authentication, wherein the customer information comprises a customer ID. In step S505, when the customer information is certified, the procedure jumps to step S506. If the customer information is not certified, the procedure jumps to an error handling state. In step S506, the authentication system acquires a customer ID from the provided customer information, and writes and locks the customer ID in a register (e.g. 22b of FIG. 2 or 45 of FIG. 4) in step S507. Then, in step S508, the authentication system generates a MAC for the provided customer information using a HU key (e.g. 26 of FIG. 2) and the customer ID stored in the register. In step S509, the authentication system writes the customer information, the generated MAC, and the flash program to an external flash memory (e.g. 29 of FIG. 2). After step S509, the whole system is reset again.

If there is no flash program to be downloaded, the procedure jumps to step S510. In step S510, the authentication system reads the customer information from an external flash memory and acquires a customer ID from the read customer information in step S511. In step S512, the authentication system writes and locks the customer ID in a register (e.g. 22b of FIG. 2 or 45 of FIG. 4). In step S513, the authentication system generates a MAC for the provided customer information using the HU key (e.g. 26 of FIG. 2) and the customer ID stored in the register. In step S514, the authentication system determines whether the generated MAC is the same as the MAC stored in the external flash memory. If not, the procedure jumps to an error handling state. If yes, the whole system is boot with the flash program stored in the external flash memory. It is to be understood that the authentication system may be practiced by dedicate hardware circuits or a MCU (e.g. 21 of FIG. 2).

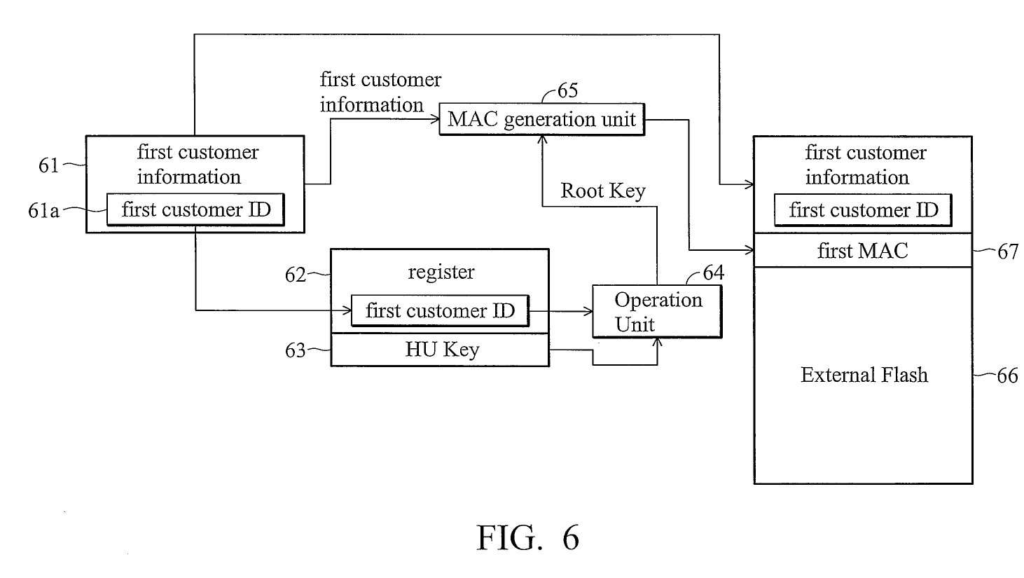

FIG. 6 is a schematic diagram for MAC generation during flash program download. Referring to steps S503 to S509 of FIG. 5, before downloading a flash program, first customer information 61 corresponding to the flash program is provided for authentication. When the first customer information 61 is certified, the first customer information 61 comprising a first customer ID 61a is transmitted to a MAC generation unit 65 and the first customer ID 61a is written to the register 62. When the whole system is reset, the above mentioned boot ROM program clears the original content of the register 62 and then writes customer information to the register 62. In this embodiment, the content of the register 62 is locked to avoid modification of the stored customer ID until the next system reset. When the customer information is not certified, the MAC generation procedure jumps to an error handling state. The operation unit 64 acquires the first customer ID from the register 62, and a HU key to generate a root key. The MAC generation unit 65 generates a first MAC 67 based on the root key and the first customer information 61. The MAC generation unit 65 may generate the first MAC 67 by encrypting the first customer information 61 using the root key. It is to be understood that the first MAC 67 is utilized to verify the validity and integrity of the first customer information 61. Modification of one of the first MAC 67 and the first customer information 61 will violate the subsequent authentication. In another embodiment, the MAC generation unit 65 can be replaced by a key generator to generate another unique key based on the root key and the first customer ID 61a. Then, the customer information 61 and the first MAC 67 are written to an external flash memory 66. In this embodiment, the root key may be any arithmetic result of the HU key 63 and the first customer ID 61a. For example, the root key may be generated by adding the HU key 63 to the customer ID 61a, subtracting the the HU key 63 from customer ID, multiplying the customer ID 61a by the HU key 63, or dividing the customer ID 61a into the HU key 63. Furthermore, the root key may be a bitwise AND, OR or XOR result of the customer ID 61a to the HU key 63. In another embodiment, the root key may be any arithmetic result of the HU key 63 and the customer information 61. In this embodiment, the MAC generation 65 may be practiced by hardware circuits or a processor executing particular program code.

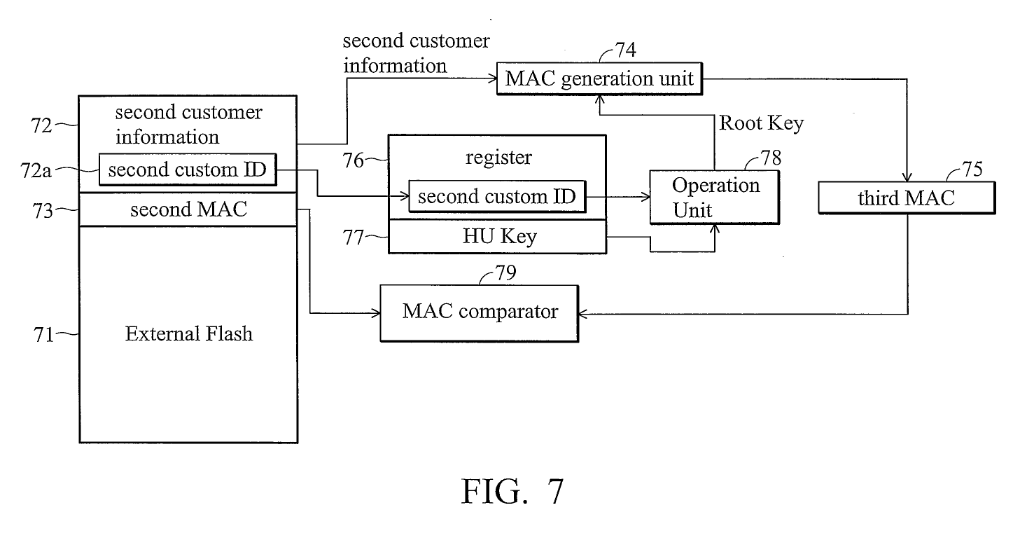

FIG. 7 is a schematic diagram for MAC generation and validation during system booting. Referring to steps S510 to S515 of FIG. 5, supposing that second customer information 72 comprising a second customer ID 72a, and a second MAC 73 are already provided in an external flash memory 71 before the current system reset. An authentication system reads the second customer information 72 from the external flash memory 71 and acquires the second customer ID 72b from the read customer information. When the whole system is reset, the above mentioned boot ROM program clears the original content of the register 62 and then writes the second customer ID 72a in a register 76. In this embodiment, the content of the register 76 is locked to avoid modification of the stored customer ID until the next system reset. Similar with the operation unit 64 of FIG. 6, the operation unit 78 acquires the second customer ID from the register 76 and a HU key 77 to generate a root key. The MAC generation unit 74 generates the third MAC 75 based on the root key and the second customer ID 72b. It is to be understood that the generation algorithms of root key and the third MAC 75 should be the same as that for generation of the second MAC 73. A MAC comparator 79 authenticates a flash program of the external flash memory 71 by determining whether the generated third MAC 75 is the same as the second MAC 73 stored in the external flash memory 71. If not, the procedure jumps to an error handling state. If yes, system booting is performed with the flash program stored in the external flash memory 71. It can be deduced that the flash program is successfully authenticated (i.e. the second MAC 73 equals the third MAC 75) only when the first customer information 61, customer ID 61a and MAC 67 respectively equals second customer information 72, customer ID 72a and MAC 73. In this embodiment, the MAC generation 74 may be practiced by hardware circuits or a processor (e.g. 21 of FIG. 2) executing program code.

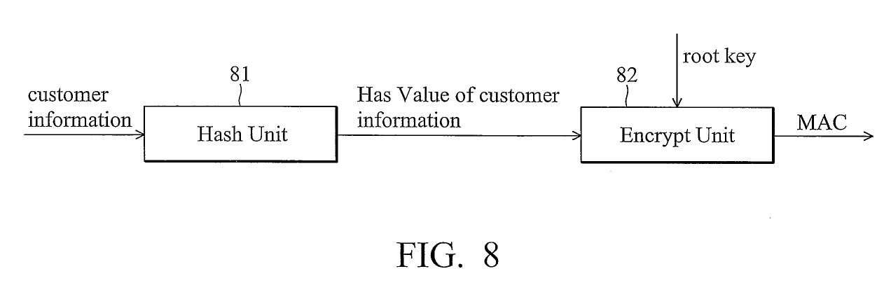

FIG. 8 is a diagram of an embodiment of a MAC generation unit according to the invention, comprising a hash unit 81 and an encrypt unit 82. The hash unit 81 receives the customer information and generates a hash value of the customer information using a well-known hash function. The hash function turns a variable-sized of customer information into a fixed-sized and relatively small-sized output (i.e. hash value) served as a digital “fingerprint” of the customer information. The encrypt unit 82 generates a MAC by encrypting the hash value using the root key.

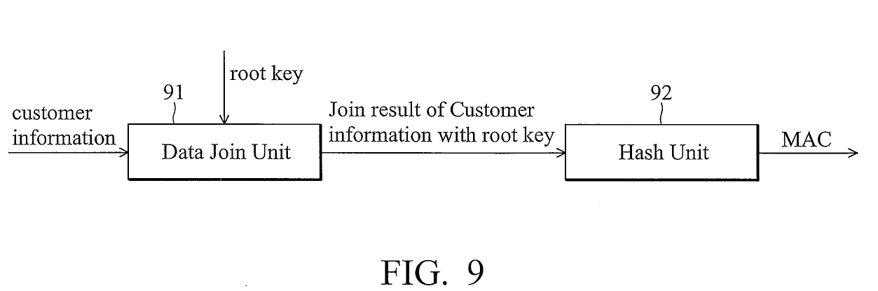

FIG. 9 is a diagram of another embodiment of a MAC generation unit according to the invention, comprising a data joint unit 91 and a hash unit 92. The data joint unit 91 combines the customer information with the root key to generate a joint result. In this embodiment, the joint result may be any arithmetic result of the root key and the customer information. The hash unit 92 generates a hash value of the joint result of the customer information with the root key using a well-known hash function, considered as a MAC.

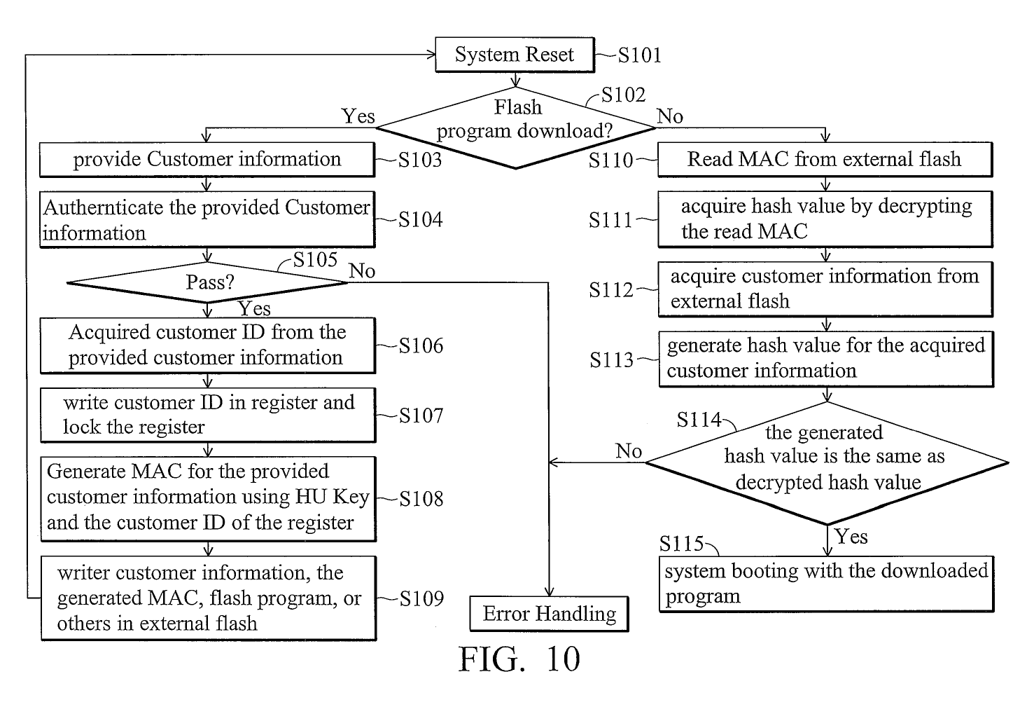

FIG. 10 is a flowchart of another embodiment of an authentication method performed by an authentication system according to the invention. In the step S101, the whole system is reset. In step S102, the authentication system detects whether a flash program is to be downloaded according to an external control signal. Note that the flash program may be downloaded from an external electronic apparatus such as a personal computer, a notebook, a personal digital assist, a mobile phone, a smart phone and the like. If a flash program is waiting to be downloaded, the method processes steps S103 to S109. If there is no flash program to be downloaded, the method processes steps S110 to S115. In step S503, customer information corresponding to the flash program is provided for authentication, wherein the customer information comprises a customer ID. In step S105, when the customer information is certified, the procedure jumps to step S106. If the customer information is not certified, the procedure jumps to an error handling state. In step S106, the authentication system acquires a customer ID from the provided customer information, and writes and locks the customer ID in a register (e.g. 22b of FIG. 2 or 45 of FIG. 4) in step S107. Then, in step S108, the authentication system generates a MAC for the provided customer information using a HU key (e.g. 26 of FIG. 2) and the customer ID stored in the register. In step S109, the authentication system writes the customer information, the generated MAC, and the flash program to an external flash memory (e.g. 29 of FIG. 2). After step S109, the whole system is reset again.

If there is no flash program to be downloaded, the procedure jumps to step S110. In step S110, the authentication system reads the MAC from an external flash memory and acquires a second hash value by decrypting the read MAC in step S111. Then, the authentication system acquires the customer information from the external flash in step S112 and transmits the customer information to a hash value generator to generate a first hash value for the acquired customer information in the step S113. In the step S114, the authentication system determines whether the first hash value is the same as the second hash value. If yes, the procedure jumps to the step S115 and the whole system boots with the flash program originally stored in the external memory. If not, the procedure jumps to an error handling state. It is to be understood that the authentication system may be practiced by dedicate hardware circuits or a MCU (e.g. 21 of FIG. 2).

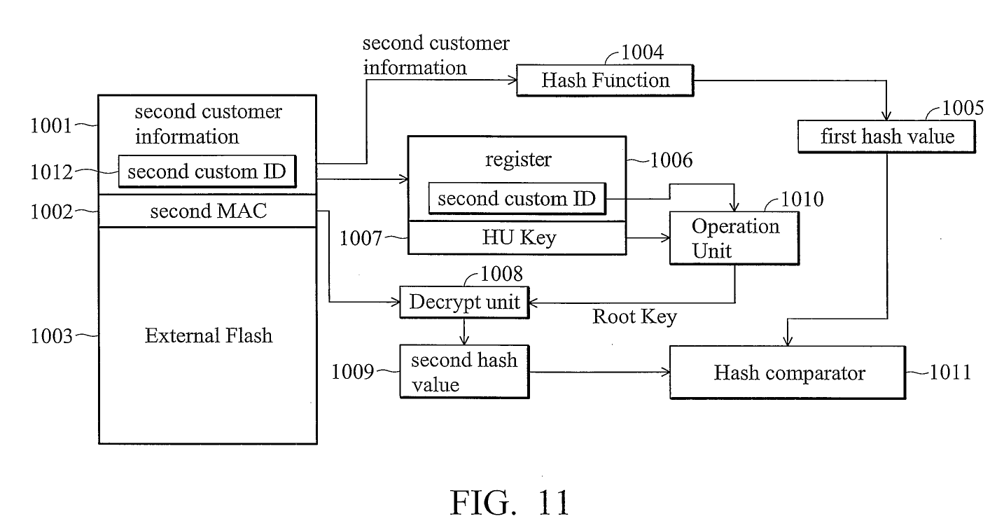

FIG. 11 is a schematic diagram for MAC generation and validation during system booting. Referring to steps 510 to S115 of FIG. 10, supposing that second customer information 1001 comprising a second customer ID 1012, and a second MAC 1002 are already provided in an external flash memory 1003 before the current system reset. When the whole system is reset, the aboved mentioned boot ROM program clears the original content of the register 1006 and then writes customer ID 1012 to the register 1006. In this embodiment, the content of the register is locked to avoid modification of the stored customer ID until the next system reset. The decrypting unit 1008 acquires the second MAC 1002 from the external flash memory 1003. After that, the decrypting unit 1008 generates a second hash value 1009 based on a root key. The operation unit 1010 acquires a customer ID from the register 1006 and the HU key 1007 to generate the root key. A hash value generator 1004 acquires the second customer information 1001 from the external flash memory 1001 and generates a first hash value 1005 for the acquired customer information 1001 using a well-known hash function. The hash value comparator 1011 then compares the first hash value 1005 and the second hash value 1009. When the first hash value 1005 is the same as the second hash value 1009, a signal is output by the hash value comparator 1011 to indicate that a flash program corresponding to the second customer information 1001 is authenticated, otherwise, a signal is output by the hash value comparator 1011 to indicate that a flash program corresponding to the second customer information 1001 is not authenticated. In this embodiment, the hash value comparator 1011 may be practiced by hardware circuits or a processor (e.g. 21 of FIG. 2) executing a particular software code.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for authenticating a flash program, comprising:
a hardware unique key;
a register, storing a customer identity (ID); and
a message authentication code (MAC) generation unit, acquiring a root key corresponding to the hardware unique key and the customer ID, and generating a first MAC for the flash program using the acquired root key,
wherein the content of the register is locked to avoid modification of the stored customer ID until the next system reset.

2. The apparatus as claimed in claim 1, further comprising a lock circuit for locking the register after the customer ID is written to the register.

3. The apparatus as claimed in claim 1, further comprising a boot ROM storing a booting program for writing the customer ID to the register.

4. The apparatus as claimed in claim 3, wherein the booting program is activated in response to a system reset signal and the register is also initialized in response to the system reset signal.

5. The apparatus as claimed in claim 1, further comprising an operation unit receiving the customer ID and the hardware unique key to generate the root key.

6. The apparatus as claimed in claim 1, wherein the MAC generation unit comprises:
a hash unit generating a hash value corresponding to customer information comprising the customer ID; and
an encrypt unit generating the first MAC by encrypting the hash value using the acquired root key.

7. The apparatus as claimed in claim 1, wherein the MAC generation unit comprises:
a data joint unit generating a first result corresponding to the customer ID and the hardware unique key; and
a hash unit generating a hash value of the first result as the first MAC.

8. The apparatus as claimed in claim 1, wherein the apparatus is embedded in an electronic device and the electronic device is boot with the flash program when the first MAC is authenticated.

9. The apparatus as claimed in claim 8, further comprising:
an external flash memory for storing a second MAC; and
a comparator for comparing the first MAC with the second MAC, and determining that the first MAC is authenticated when the first MAC is the same as the second MAC.

10. The apparatus as claimed in claim 1, further comprising a lock circuit for locking the customer ID after completely writing the customer ID to the register.

11. A method for authenticating a flash program, performed by an electronic device, comprising:
acquiring a hardware unique key corresponding to the electronic device;
acquiring a customer identity (ID) corresponding to a customer;
acquiring a root key corresponding to the hardware unique key and the customer identity; and
generating a first message authentication code (MAC) for the flash program using the acquired root key.

12. The method as claimed in claim 11, wherein the customer ID is written and locked in a register until the next system reset.

13. The method as claimed in claim 11, further comprising:
downloading the flash program;
writing and locking the customer ID in a register; and
writing the MAC and the flash program to an external memory,
wherein the customer ID cannot be modified by any means until the next system reset.

14. A method for authenticating a flash program, performed by an electronic device, comprising:
acquiring a first message authentication code (MAC);
acquiring a customer identity (ID) corresponding to a customer and the flash program;
determining whether the first MAC corresponds to the flash program; and booting the electronic device with the flash program when the first MAC corresponds to the customer ID.

15. The method as claimed in claim 11, wherein the determining step further comprises:
acquiring a hardware unique key corresponding to the electronic device;
generating a root key according to the customer ID and the hardware unique key;
acquiring customer information comprising the customer ID;
generating a second MAC by encrypting the customer information using the generated root key; and
determining that the first MAC and the customer ID corresponds to the customer ID when the first MAC is the same as the second MAC.

16. The method as claimed in claim 11, further comprising:
writing the customer ID in a register; and
locking the customer ID after writing the customer ID to avoid further modification.

17. The method as claimed in claim 11, wherein the determining step further comprises:
acquiring a hardware unique key corresponding to the electronic device;
generating a root key according to the customer ID and the hardware unique key;
acquiring customer information comprising the customer ID;
acquiring a first hash value of the acquired customer information by a hash function;
acquiring a second hash value by decrypting the first MAC using the generated root key; and
determining that the first MAC and the customer ID corresponds to the customer ID when the first hash value is the same as the second hash value.

18. An apparatus for authenticating a flash program in an electronic device, comprising:
a hardware unique key;
a register, storing a customer identity (ID);
a key generation unit, for generating a root key according to the customer ID and the hardware unique key; and
a lock circuit for locking the content of the register to avoid modification of the stored customer ID until the next system reset.

19. The apparatus as claimed in claim 18, wherein the register is a first D flip-flop.

20. The apparatus as claimed in claim 19, wherein the lock circuit further comprises:
a second D flip-flop;
a OR gate;
an inverter; and
an AND gate,
wherein the OR gate is coupled between a output and a first input of the second D flip-flop, the inverter is coupled between the output of the second D flip-flop and a first input of the AND gate, and a output of the AND gate is coupled to a clock input of the first D flip-flop.

21. The apparatus as claimed in claim 20, wherein the OR gate further comprises a second input, the second flip-flop comprises a second input and a clock input, the AND gate comprises a second input of one, when system reset, the second input of the OR gate is set to zero, the second input of the second D flip-flop receives a signal SYSTEM RESET to clear the data latched therein, and after completing writing of the customer ID, the second input of the OR gate is set to one.
